(19) United States
(12) Patent Application Publication
(10) Pub. No.: US 2016/0227258 A1
(43) Pub. Date: Aug. 4, 2016

(54) METHOD FOR PLAYING BACK LIVE VIDEO AND DEVICE

(71) Applicant: TENCENT TECHNOLOGY (SHENZHEN) COMPANY LIMITED, Guangdong (CN)

(72) Inventor: Chun ZHANG, Shenzhen (CN)

(21) Appl. No.: 15/021,379

(22) PCT Filed: Sep. 12, 2014
(86) PCT No.: PCT/CN2014/086424

§ 371 Date: Mar. 11, 2016

(30) Foreign Application Priority Data
Sep. 13, 2013 (CN) 201310418555.3

(51) Int. Cl. H04N 21/218; H04N 21/231; G11B 27/34; H04N 21/472; H04N 21/262; H04N 21/845; H04N 21/2187; H04N 21/239

(52) U.S. Cl. CPC H04N 21/2181; H04N 21/2187; H04N 21/23106; H04N 21/2393; H04N 21/47217; H04N 21/26258; H04N 21/8455; H04N 21/8456; G11B 27/34

(57) ABSTRACT

Disclosure is a method for playing back live video. The method includes: receiving real-time video fragment data of a video; storing the real-time video fragment data into a cache and a file system respectively; obtaining index information of all the real-time video fragments in a predetermined playing back time period before the current time; generating an index file according to the index information, sending the index file to a client, and feeding back a real-time video fragment to the client according to the playback request of the client. The device for playing back live video is also disclosed. The method and the device for playing back live video can realize play back the live video at any time period, and a timeliness of playing back live video is improved.

### CROSS-REFERENCE TO RELATED APPLICATIONS

This application claims the benefit of priority from Chinese Patent Application NO. 201310418555.3 filed on Sep. 13, 2013, the content of which is hereby incorporated in its entire by reference.

### TECHNICAL FIELD

The present disclosure relates to the fields of computer technologies, and specifically to, an application program interface display method, a device, a terminal and a readable storage medium.

### BACKGROUND

HTTP live streaming (HLS) is a streaming media network transport protocol which is put forward by Apple Inc. based on hypertext transfer protocol (HTTP).

In the existing technology, HLS live video playing back technology can be realized by means of the following two ways. In a first way, a function of playing back live video for a user is realized by storing part live data in a memory of a server or in a cache of a local disk. In a second way, the function of playing back live video for a user is realized by recording the whole show video first, and then playing the show video in the form of video on demand.

However, in the above-mentioned existing technology, the first way has a larger limitation, due to a limitation of storage capacity of the sever, the server can only stores the video stream in the last few minutes in the cache, but not support to play back the video stream for a long time. Additionally, when the video stream is stored in the local disk, because of the read/write bottleneck of a single disk, the local disk does not support the function of playing back live video in multi-channel and on a large scale. In the second way, after recording the whole show video, the show video needs to be processed such as transcoding, distributing, etc. so as to provide a playable video for the user. Thus, a timeliness of playing the show video is poor.

### SUMMARY

In A method for playing back live video and a device are provided in present disclosure, in which video fragments of the live video can be stored in a distributed system, thereby, a speed of playing back the live video is improved, and a timeliness of playing back the live video is enhanced.

In the embodiment of present disclosure, a method for playing back live video includes:
receiving real-time video fragment data of a video;
storing the real-time video fragment data into a cache and a file system respectively;
querying the cache and the file system to obtain index information of all the real-time video fragments in a predetermined playing back time period before the current time;
generating an index file according to the index information, and sending the index file to a client, wherein the index file is configured to make the client to display a playback progress bar on the client and to receive a playback request of a user through the playback progress bar; and
feeding back a corresponding real-time video fragment to the client according to the playback request of the client.

In the embodiment of present disclosure, a device for playing back live video includes:
a receiving module configured to receive a real-time video fragment data of a video;
a storing module configured to store the real-time video fragment data received by the receiving module into a cache and a file system respectively;
an obtaining module configured to query the cache and the file system to obtain index information of all real-time video fragments in a predetermined playing back time period before the current time;
a generating module configured to generate an index file according to the index information;
a sending module configured to send the index file generated by the generating module to a client, wherein the index file is configured to make the client to display a playback progress bar on the client, and to receive a playback request of a user through the playback progress bar;
the sending module further configured to feed back a corresponding real-time video fragment to the client according to the playback request of the client.

The method for playing back live video and the device for playing back live video in the embodiment of present disclosure, the real-time video fragment data received by the server is stored into the cache and the file system. The index information of all the real-time video fragments in a predetermined playing back time period before the current time are obtained from the cache and the file system. The index information corresponds to the storage locations of all the real-time video fragments. The index file is generated according to the index information and is sent to the client. The user can send a playback request to the client through the index file. The server can send the real-time video fragments corresponding to the playback request to the client. By this means, playing back live video is realized in real-time when the user watches the live video. Since the cache of the sever and the file system store all the real-time video fragments of the live video, the server sends the index information of all the real-time video fragments to the client, so that the user can play back any time period of the live video through the client, which has strong timeliness, and can play back the live video for a long period of time in real-time.

In order to make embodiments of present disclosure more clearly, the drawings which are needed in the embodiments of present disclosure are described simply as follows. It is obviously, the drawings described as the follows are only exemplary embodiments of present disclosure. To a person of ordinary skill in the art, under premise of no creative work, other drawings may be obtained according to the drawings.

### BRIEF DESCRIPTION OF THE DRAWINGS

FIG. 1 is a flowchart of a method for playing back live video according to one embodiment of present disclosure.

FIG. 2 is a schematic diagram of a displaying interface of a client displaying a live video image according to an embodiment of present disclosure.

FIG. 3 is a flowchart of a method for playing back live video according to another embodiment of present disclosure.

FIG. 4 is a schematic diagram of a data structure of a video file stored in a file system according to one embodiment of present disclosure.

FIG. 5 is a schematic diagram of a device for playing back live video according to one embodiment of present disclosure.

FIG. 6 is a schematic diagram of a device for playing back live video according to another embodiment of present disclosure.

### DETAILED DESCRIPTION OF ILLUSTRATED EMBODIMENTS

In order to detailedly illustrate the technical manners and technical effect of present disclosure, further description of detail method, structure, feature and effect of present disclosure will be illustrated clearly and completely as the follows, which combined with embodiments in drawings and detailed embodiment.

The working principle of HLS (HTTP live streaming) is: dividing a whole video stream into several small files based on HTTP, and downloading a file every time. The HLS only requests a basic HTTP message, thus, the HLS can pass through any firewall or a proxy server which allows HTTP data to access. In addition, the HLS can transmit a media stream by using a content distribution network.

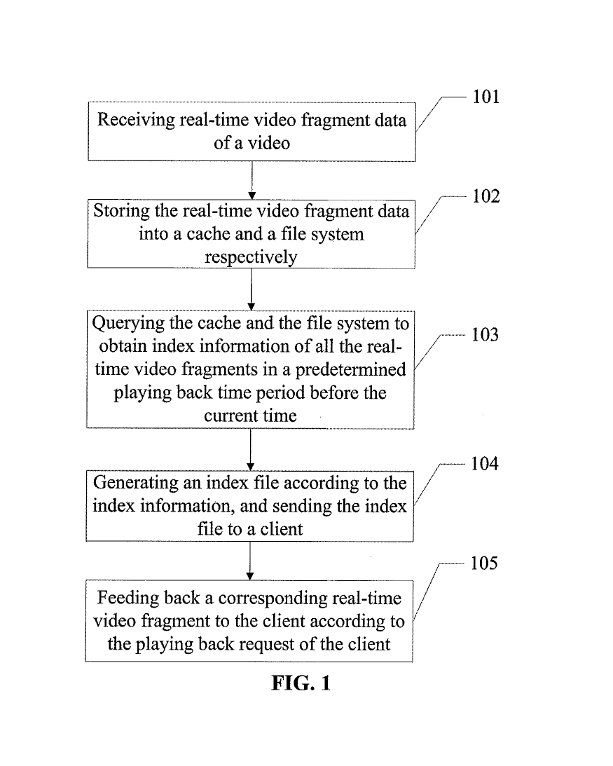

Referring to FIG. 1, FIG. 1 is a flowchart of a method for playing back live video according to one embodiment of present disclosure. The method for playing back live video includes the following steps.

Step 101, receiving real-time video fragment data of a video.

The server receives real-time video fragment data of a video. The real-time video fragment data is generated by an encoder. For example, the real-time video fragment generated by the encoder can be a transport stream (TS) file, the real-time video fragment data can be a video data for a period of about 10 seconds long, and creation time information is recorded in the real-time video fragment data; creation time is the absolute time to guarantee the uniqueness of each real-time video fragment and the sequence of each real-time video fragment of the video.

Step 102, storing the real-time video fragment data into a cache and a file system respectively.

The server stores the real-time video fragment data into the cache of the server and the file system. In the embodiment, the file system can be a distributed system. The distributed system has an ability of accessing a remote file, and managing and accessing files distributed on the network in a transparent manner.

In the embodiment of present disclosure, since the cache of the server usually can only cache less real-time video fragment, so video playback time of the live video which is provided for the user to play back is usually shorter, such as, 2 minutes. In other words, the real-time video fragment stored in the cache of the server can only provides a period of 2 minutes long videos for the user to play back the live videos. More real-time video fragments are stored into the file system, for the user to play back the live videos.

Step 103, querying the cache and the file system to obtain index information of all the real-time video fragments in a predetermined playing back time period before the current time.

In the cache of the server and the file system, the index information of all real-time video fragments obtained in the predetermined playing back time period before current time includes: the index information stored in the cache of the sever, and the index information of the real-time video fragments obtained from the file system. The real-time video fragments stored in the cache of the server and the file system in the predetermined playing back time period before current time can be obtained according to the index information. Thus, by this means, all the real-time video fragments of the video can be obtained and further provided for the user to play back the live video.

Step 104, generating an index file according to the index information, and sending the index file to a client, wherein, the index file is configured to make the client to display a playback progress bar on the client and to receive a playback request of the user through the playback progress bar.

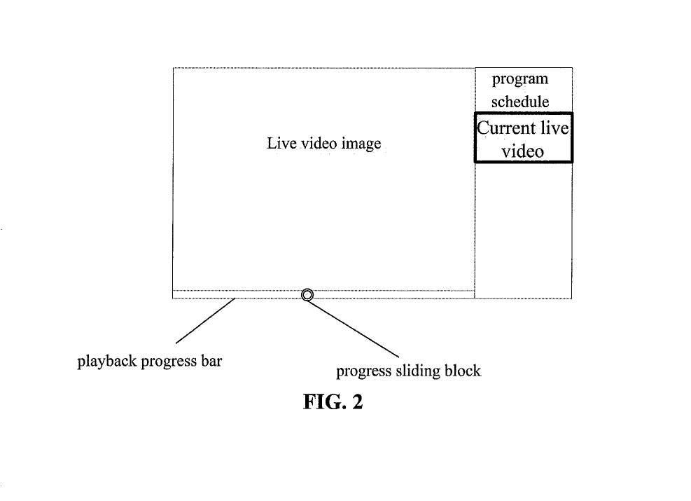

The server generates an index file according to the index information. The index file is configured to make the client to display a playback progress bar. Referring to FIG. 2, FIG. 2 is schematic diagram of a displaying interface of a client displaying a live video image according to an embodiment of present disclosure. As shown in FIG. 2, the live video image can display the content of a current live video in a programme schedule. The index file generated by the sever makes the client to display the playback progress bar on the client, and further makes the client to receive the playback request of the user through the playback progress bar. The user can send the playback request to the client by dragging a progress sliding block of the playback progress bar.

Step 105, feeding back a corresponding real-time video fragment to the client according to the playback request of the client.

The client displays the playback progress bar according to the index file, the user sends the playback request by operating (such as dragging) the playback progress bar to the client, and the server can feed back the real-time video fragment corresponding to the playback request to the client according to the playback request send by the client. By this means, playing back live video in real-time is realized when the user watches the live video.

In the embodiment of present disclosure, the real-time video fragment data received by the server is stored into the cache and the file system. The index information of all the real-time video fragments in a predetermined playing back time period before the current time are obtained from the cache and the file system. The index information corresponds to the storage locations of all the real-time video fragments. The index file is generated according to the index information and is sent to the client. The user can send a playback request to the client through the index file. The server can send the real-time video fragments corresponding to the playback request to the client. By this means, playing back live video is realized in real-time when the user watches the live video. Since the cache of the sever and the file system store all the real-time video fragments of the live video, the server sends the index information of all the real-time video fragments to the client, so that the user can play back any time period of the live video through the client, which has strong timeliness, and can play back the live video for a long period of time in real-time.

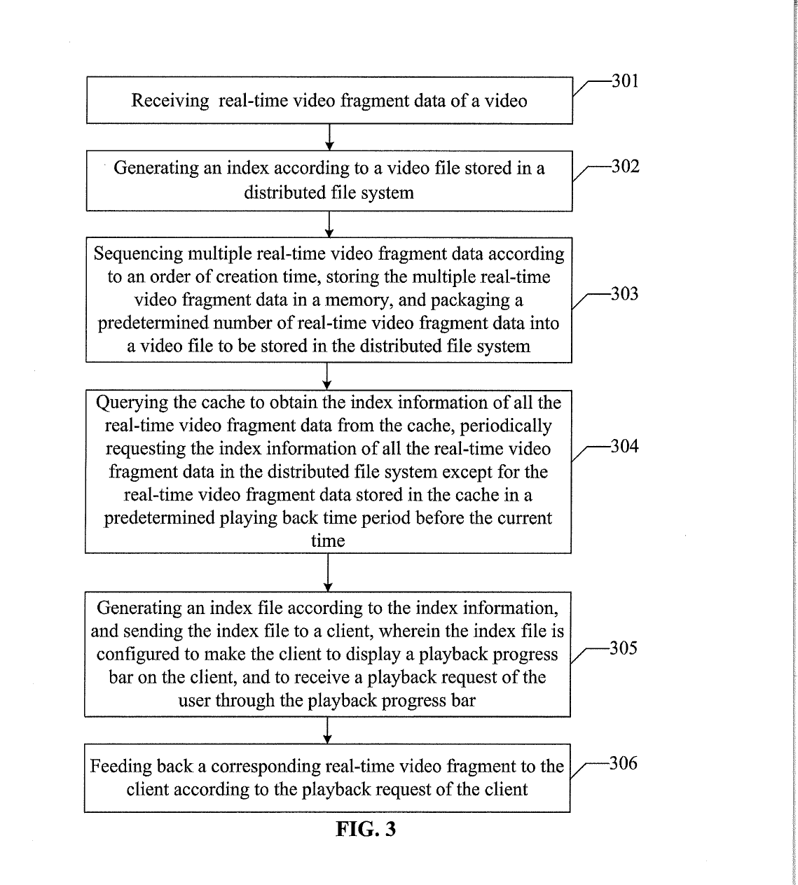

Referring to FIG. 3, FIG. 3 is a flowchart of a method for playing back live video according to another embodiment of present disclosure. The method for playing back live video includes the following steps.

Step 301, receiving real-time video fragment data of a video.

The server receives the real-time video fragment data of a video; the real-time video fragment data has creation time information.

Step 302, generating an index according to a video file stored in a distributed file system.

In the embodiment of present disclosure, in order to reduce the number of files stored in the distributed file system, multiple real-time video fragments can be packed together to form a video file, and then the video file is stored in the distributed file system.

The way of generating index information for the video file can be realized by using an internal index to mark starting time, end time, an offset and data length of each real-time video fragment in the video fragment, and generating corresponding index information for each real-time video fragment of the video file. The index information can accurately position the data of each video fragment.

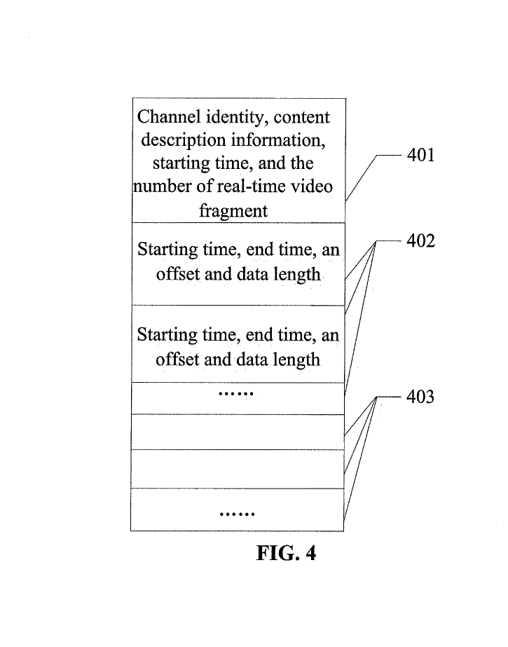

Referring to FIG. 4, FIG. 4 is a schematic diagram of a data structure of a video file stored in a file system according to one embodiment of present disclosure. The data structure of the video file can be divided into three parts: video file description information 401, internal data index information 402 and video fragment data 403. The video file description information 401 can include: channel identity (ID), content description information, starting time, and the number of real-time video fragment. The internal data index 402 can include: starting time, end time, an offset and data length of each real-time video fragment in the video fragment. The video fragment data 403 is a detailed data part of each video fragment. Each ellipsis shown in FIG. 4 represents that the content in the current block is the same with the content in the previous box.

Step 303, sequencing multiple real-time video fragment data according to an order of creation time, storing the multiple real-time video fragment data in a memory, and packaging a predetermined number of real-time video fragment data into a video file to be stored in the distributed file system.

The server receives the real-time video fragment data, and stored the real-time video fragment data into the memory of the server in a way of queue. In other words, the several real-time video fragment data are sequenced according to an order of creation time, and then are stored into the memory. The queue length is fixed, that is, a predetermined number of real-time video fragment data is sequenced.

The server packages the predetermined number of real-time video fragment data which has been sequenced into a video file, and stores the video file into the distributed file system. Thus, the number of real-time video fragments is reduced, for example, every 30 real-time video fragments are packed into a video file to be stored. When the video file is stored, the video file can be named as “channel identity+date+sequence number of video file”. For example, the video file to be stored is: a video of the CCTV sports channel on Sep. 1, 2013, and the sequence number of the video file is the fifth; therefore, the video file can be named as CCTV520130901005.

Step 304, querying the cache to obtain the index information of all the real-time video fragment data from the cache, periodically requesting the index information of all the real-time video fragment data in the distributed file system except for the real-time video fragment data stored in the cache in a predetermined playing back time period before the current time.

The capacity of the cache of the server is limited, and the cache of the server can only store less real-time video fragment data, so the playing time of the real-time video fragment data is very short, usually only for a few minutes. The rest of real-time video fragment data of the video can be obtained from the distributed file system, thus the user can play back any content of the whole video at any time.

The index information of the all the real-time video fragment data in the cache is obtained by querying the cache, and storage locations of all the real-time video fragment data in the cache can be obtained according to the index information obtained from the cache. In the predetermined playing back time period before the current time, the index information of the real-time video fragment data in a time period except for the real-time video fragment data stored in the cache needs to be obtained from the distributed file system. The storage locations of all the real-time video fragment data in the distributed file system can be obtained according to the index information obtained from the distributed file system.

For example, the current time is 15:00:00, the playing back time period before the current time is 50 minutes, the video playback time of the real-time video fragment stored in the cache is 2 minutes, a 50 minutes lone real-time video fragment is all stored in the file system. Thus, the index information of all the real-time video fragments in the predetermined playing back time period before the current time can be obtained by querying the cache of the server and the file system, and all the 50 minutes long real-time video fragment can also be obtained and provided for the user to play back the live video.

In order to prevent any omission of all the real-time video fragment data corresponding the index information of the real-time video fragment data obtained from the cache of the server and the index information of the real-time video fragment data which is obtained from the distributed file system, and further prevent the user from playing back the video. In the embodiment of the present disclosure, the real-time video fragments in the cache and the real-time video fragments in the distributed file system may be overlapped partially. Thus, if the index information of the cache and the index information of the distributed file system are pointed at the same real-time video fragment data overlappingly, then the real-time video fragment data are obtained according to the index information of the cache. In other words, if the index information pointed at the same real-time video fragment data overlappingly exists, it means that the same real-time video fragment data is stored in the cache of the server, and stored in the distributed file system at the same time. Then the real-time video fragment data is read from the cache faster according to the index information of the cache, which thereby can save more time.

Step 305, generating an index file according to the index information, and sending the index file to a client, wherein the index file is configured to make the client to display a playback progress bar on the client, and to receive a playback request of the user through the playback progress bar.

The server generates an index file according to the index information, and sends the index file to the client. The index file can be a file of m3u8 format.

Step 306, feeding back a corresponding real-time video fragment to the client according to the playback request of the client.

The client displays the playback progress bar according to the index file, the user sends the playback request by operating (such as dragging) the playback progress bar to the client, and the server can feed back the real-time video fragment corresponding to the playback request to the client according to the playback request send by the client. By this means, playing back live video in real-time is realized when the user watches the live video.

Referring to FIG. 2 again, as shown in FIG. 2, the live video image displays a current live video in a program schedule. The index file generated by the sever makes the client to display the playback progress bar on the client, and further makes the client to receive the playback request of the user. The user can send the playback request to the client by dragging a progress sliding block of the playback progress bar. The server feeds back the real-time video fragments to the client according to the playback request, and the real-time video fragments are played to the user by the client.

In the embodiment of present disclosure, the server stores the real-time video fragment data into the cache and the file system. Before the server stores the real-time video fragment data into the file system, index information for each real-time video fragment of video file is generated by using an internal index to mark starting time, end time, an offset and data length of each real-time video fragment in the video fragment, and generating corresponding index information for each real-time video fragment of the video file. Thus, the real-time video fragment can be accurately obtained from the video file, and a success rate of playing back the video is improved. The real-time video fragment data according to an order of a creation time are sequenced, stored in a memory, and a predetermined number of real-time video fragment data are packaged into a video file to be stored in the distributed file system. Thus, an order of each real-time video fragment in the video file is guaranteed. The index information of all real-time video fragment data are obtained from the cache and file system in a predetermined playing back time period before the current time. The index information is the storage locations of all real-time video fragments. If the index information of the cache and the index information of the distributed file system are pointed at the same real-time video fragment data overlappingly, then the real-time video fragment data are obtained according to the index information of cache. Thus, the real-time video fragment data is read from the cache faster according to the index information of the cache, which thereby can save more time. An index file is obtained according to the index information which is obtained, and the index file is sent to the client, thus the user can send a playback request to the client through the index file. The server sends the real-time video fragment to the client according to the playback request sent from the client, thus the user can play back the live video when the user watches live video. Because the sever stores part real-time video fragment, and the file system stores more real-time video fragments of live video, all real-time video fragments of the live video can be obtained from the server and the file system. The user can play back any time period of the live video through the client, which has strong timeliness, and can play back the live video for a long period of time in real-time.

Referring to FIG. 5, FIG. 5 is a schematic diagram of a device for playing back live video according to one embodiment of present disclosure. The device for playing back live video includes the following module.

A receiving module 501 is configured to receive real-time video fragment data of a video.

A storing module 502 is configured to store the real-time video fragment data received by the receiving module 501 into a cache and a file system respectively.

An obtaining module 503 is configured to querying the cache and the file system to obtain index information of all the real-time video fragments in a predetermined playing back time period before the current time.

A generating module 504 is configured to generate an index file according to the index information.

A sending module 505 is configured to send the index file generated by the generating module 504 to a client, wherein the index file is configured to make the client to display a playback progress bar on the client, and to receive a playback request of a user through the playback progress bar.

The sending module 505 is further configured to feed back a corresponding real-time video fragment to the client according to the playback request of the client.

A process of realizing each module of the device for playing back live video of the embodiment of present disclosure can refer the above description of FIG. 1, and it is not repeat here.

In the embodiment of present disclosure, the receiving module 501 receives the real-time video fragment data. The storing module 502 stores the real-time video fragment data received into a cache and a file system respectively. The obtaining module 503 obtains index information of all the real-time video fragments in a predetermined playing back time period before the current time from the cache and the file system. The index information corresponds to the storing locations of all the real-time video fragments. The generating module 504 generates an index file according to the index information. The sending module 505 sends the index file to a client, thus the user can send a playback request to the client through the index file. The sending module 505 sends the real-time video fragment to the client according to the playback request sent by the client. By this means, playing back live video is realized in real-time when the user watches the live video. Since the cache of the sever and the file system store all real-time video fragments of the live video, the server sends the index information of all the real-time video fragments to the client, so that the user can play back any time period of the live video through the client, which has a strong timeliness, and can play back the live video for a long period of time in real-time.

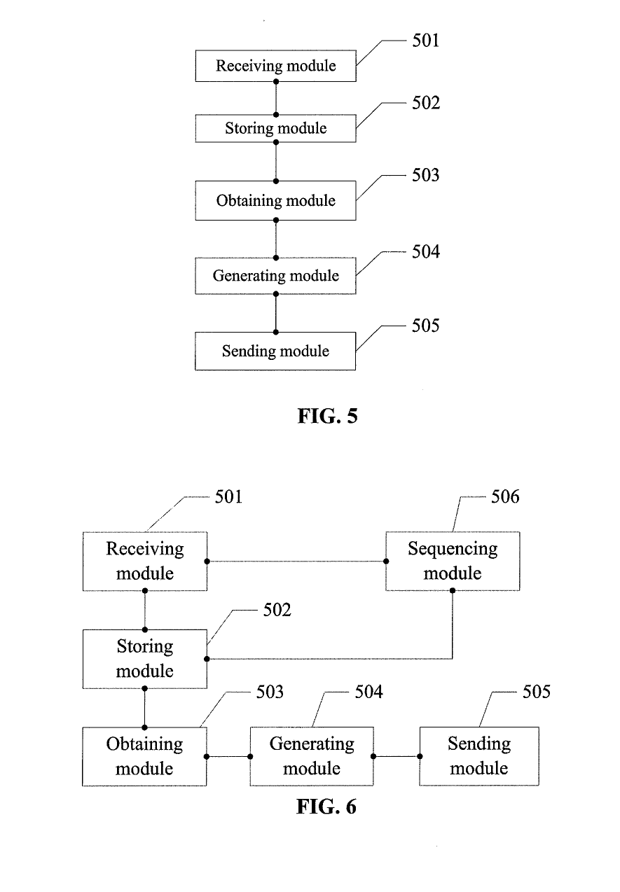

Referring to FIG. 6, FIG. 6 is a schematic diagram of a device for playing back live video according to another embodiment of present disclosure. As shown in FIG. 6 the device for playing back live video is different from the device for playing back live in FIG. 5, the device for playing back live video in FIG. 6 further includes the following modules.

A sequencing module 506 is configured sequence multiple real-time video fragment data according to an order of an creation time.

The storing module 502 is further configured to store the multiple real-time video fragment data sequenced by the sequencing module 506 in a memory, and package a predetermined number of real-time video fragment data into a video file to be stored in the distributed file system.

The obtaining module 503 is further configured to query the cache to obtain the index information of all the real-time video fragment data from the cache. The obtaining module 503 is further configured to periodically request the index information of all the real-time video fragment data in the distributed file system except for the real-time video fragment data stored in the cache in a predetermined playing back time period before the current time.

Further, the obtaining module 503 is further configured to obtain the real-time video fragment data according to the index information of the cache, when the index information of the cache and the index information of the distributed file system are pointed at the same real-time video fragment data overlappingly.

The generating module 504 is further configured to mark starting time, end time, an offset and data length of each real-time video fragment in the video fragment, and generate corresponding index information for each real-time video fragment of the video file.

A process of realizing the function of each module of the device for playing back live video of the embodiment of present disclosure can refer to the above descriptions of the FIG. 1 and the FIG. 2, and it is not repeat here.

In the embodiment of present disclosure, the storing module 502 stores the real-time video fragment data into the cache and the file system. Before the storing module 502 stores the real-time video fragment data into the file system, the generating module 504 generates index information for each real-time video fragment of video file by using an internal index to mark starting time, end time, an offset and data length of each real-time video fragment in the video fragment, and generating corresponding index information for each real-time video fragment of the video file. Thus, the real-time video fragment can be accurately obtained from the video file, and a success rate of playing back the video is improved. The sequencing module 506 sequences the real-time video fragment data according to an order of a creation time. The storing module 502 stores the real-time video fragment data sequenced by the order of a creation time in a memory, and packages a predetermined number of real-time video fragment data into a video file to be stored in the distributed file system. In order to guarantee an order of each real-time video fragment in the video file, the obtaining module 503 obtains the index information of all real-time video fragment data from the cache and file system in a predetermined playing back time period before the current time. The index information is the storage locations of all real-time video fragments. If the index information of the cache and the index information of the distributed file system are pointed at the same real-time video fragment data overlappingly, then the obtaining module obtains the real-time video fragment data according to the index information of cache. Thus, the real-time video fragment data is read from the cache faster according to the index information of the cache, which thereby can save more time. The generating module 504 generates an index file according to the index information which is obtained, the sending module 505 sends the index file to the client, and thus, the user can send a playback request to the client through the index file. The sending module 505 sends the real-time video fragment to the client according to the playback request sent from the client, thus the user can play back the live video when the user watches live video. Because the sever stores part real-time video fragment, and the file system stores more real-time video fragments of live video, all real-time video fragments of the live video can be obtained from the server and the file system. The user can play back any time period of the live video through the client, which has strong timeliness, and can play back the live video for a long period of time in real-time.

It should be noted that each embodiment of present disclosure is described in a progressive manner, the description emphasis of each embodiment is, different from other embodiments. The same or the similar parts of each embodiment can refer to each other. For the embodiments of device, because it is similar to the embodiments of method, the descriptions of the embodiment of device are simpler. Relevant and repetitive parts can refer to the descriptions of the embodiments of method.

It should be noted that in present disclosure, relationship terms such as “a first”, “a second” are only used to distinguish an entity or operation from the other entity or operation. It does not require any real relationship or order between the entities or operations. Further more, the term “include”, “comprise” or other variant means non-exclusive include, thus a process, or a method, or a thing, or a device includes a series of elements not only includes the series of elements but also includes other elements which are specifically list, or also includes some fixed elements of the process, or the method, or the thing, or the device. In a condition that without any more limitation, an element limited by a sentence “include a (an) . . . ” means that a process, or a method, or a thing, or a device does not rule out other same elements.

To a person of ordinary skill in the art, all steps or part steps of the above embodiments can be implemented by hardware, and can also be implemented by a hardware which is instructed by program. The program can be stored in a computer readable storage medium. Hereinto, the storage medium may be a read-only memory (ROM), a random access memory (RAM), a disk or a compact disk (CD).

Although certain embodiments of the present disclosure have been specifically described, the present disclosure is not to be construed as being limited thereto. Various changes or modifications may be made to the present disclosure without departing from the scope and spirit of the present disclosure.

1. A method for playing back live video, comprising:
receiving real-time video fragment data of a video;
storing the real-time video fragment data into a cache and a file system respectively;
querying the cache and the file system to obtain index information of all the real-time video fragments in a predetermined playing back time period before the current time;
generating an index file according to the index information, and sending the index file to a client, wherein the index file is configured to make the client to display a playback progress bar on the client and to receive a playback request of a user through the playback progress bar; and
feeding back a corresponding real-time video fragment to the client according to the playback request of the client.

2. The method for playing back live video according to claim 1, wherein the step of storing the real-time video fragment data into a cache and a file system respectively comprises:
sequencing multiple real-time video fragment data according to an order of an creation time, storing the multiple real-time video fragment in a memory, and packaging a predetermined number of real-time video fragment data into a video file to be stored the video file in the distributed file system.

3. The method for playing back live video according to claim 2, wherein the step of querying the cache and the file system to obtain index information of all the real-time video fragments in a predetermined playing back time period before the current time comprises:
querying the cache to obtain the index information of all the real-time video fragment data from the cache;
periodically requesting the index information of all the real-time video fragment data in the distributed file system except for the real-time video fragment data stored in the cache in a predetermined playing back time period before the current time.

4. The method for playing back live video according to claim 3, further comprising:
if the index information of the cache and the index information of the distributed file system being pointed at the same real-time video fragment data overlappingly, obtaining the real-time video fragment data according to the index information of the cache.

5. The method for playing back live video according to claim 2, before the step of storing the real-time video fragment data into a cache and a file system respectively, the method further comprising:
using an internal index to mark starting time, end time, an offset and data length of each real-time video fragment in the video fragment, and generating corresponding index information for each real-time video fragment of the video file.

6. A device for playing back live video, comprising:
a receiving module configured to receive real-time video fragment data of a video;
a storing module configured to store the real-time video fragment data received by the receiving module into a cache and a file system respectively;
an obtaining module configured to query the cache and the file system to obtain index information of all real-time video fragments in a predetermined playing back time period before the current time;
a generating module configured to generate an index file according to the index information;
a sending module configured to send the index file generated by the generating module to a client, wherein the index file is configured to make the client to display a playback progress bar on the client, and to receive a playback request of a user through the playback progress bar;
the sending module further configured to feed back a corresponding real-time video fragment to the client according to the playback request of the client.

7. The device for playing back live video according to claim 6, further comprising:
a sequencing module configured sequence multiple real-time video fragment data according to an order of an creation time;
the storing module further configured to store the multiple real-time video fragment data sequenced by the sequencing module in a memory, and package a predetermined number of real-time video fragment data into a video file to be stored in the distributed file system.

8. The device for playing back live video according to claim 6, wherein the obtaining module is further configured to query the cache to obtain the index information of all the real-time video fragment data from the cache; the obtaining module is further configured to periodically request the index information of all the real-time video fragment data in the distributed file system except for the real-time video fragment data stored in the cache in a predetermined playing back time period before the current time from the distributed file system.

9. The device for playing back live video according to claim 6, wherein the obtaining module is further configured to obtain the real-time video fragment data according to the index information of the cache, when the index information of the cache and the index information of the distributed file system are pointed at the same real-time video fragment data overlappingly.

10. The device for playing back live video according to claim 6, wherein the generating module is further configured to mark starting time, end time, an offset and data length of each real-time video fragment in the video fragment, and generate corresponding index information for each real-time video fragment of the video file.

11. The device for playing back live video according to claim 7, wherein the generating module is further configured to mark starting time, end time, an offset and data length of each real-time video fragment in the video fragment, and generate corresponding index information for each real-time video fragment of the video file.

12. The device for playing back live video according to claim 8, wherein the generating module is further configured to mark starting time, end time, an offset and data length of each real-time video fragment in the video fragment, and generate corresponding index information for each real-time video fragment of the video file.

13. The device for playing back live video according to claim 9, wherein the generating module is further configured to mark starting time, end time, an offset and data length of each real-time video fragment in the video fragment, and generate corresponding index information for each real-time video fragment of the video file.
